(19) United States
(12) Patent Application Publication
(10) Pub. No.: US 2007/0041034 A1
(43) Pub. Date: Feb. 22, 2007

(54) Wireless workflow system

(76) Inventor: Barry G. Gombert, Rochester, NY (US)

Correspondence Address: Clifford P. Kelly;Alix, Yale & Ristas, LLP, 750 Main Street, Hartford, CT, 06103-2721, US

(21) Appl. No.: 11/204,473

(22) Filed: Aug. 16, 2005

(51) Int. Cl. G06F 3/12

(52) U.S. Cl. 358/1.15; 358/1.13

(57) ABSTRACT

A wireless workflow system for a print shop having multiple printing components includes a workflow controller and a positioning systems associated with each printing component. A wireless local area network provides communications between the workflow controller and each positioning system, such that each positioning system provides a relative position of the associated printing component to the workflow controller.

### BACKGROUND

This disclosure relates generally to printing apparatus and methods for printing. More particularly, the present disclosure relates to printing apparatus and methods for printing in a large-scale print shop.

With the advent of modern lean manufacturing methods, information processing systems, and the Internet, manufacturing facilities are increasingly gaining the ability to acquire, process, and utilize workflow information. For example, many current print shops include isolated machines that do not interface well with internal computer systems.

Companies often organize these machines in patterns and arrays within a workspace that are not optimal from an efficiency and cost standpoint. Conventional printshops are also often organized in a manner that is functionally independent of the print job complexity, the print job mix, and the total volume of print jobs passing through the system. For instance, the machines require operators to load/unload jobs, monitor job progress, pass jobs on to a next station, and commence a new job. In-between each of the steps, each job is commonly stored in storage areas awaiting the next step of the job. An experienced manager plans and schedules each machine. Typically, a job card that specifies the steps needed to complete the job, the steps already completed, and the order of the steps, accompanies the job. An operator manually adds the data regarding job completion to a job card, or sometimes simply holds such information in his or her memory for a period.

A disadvantage of conventional printshops is that excess inventories caused by buildups between job steps increase overall job costs. The lack of real time information concerning the contemporaneous state of the machines and the jobs leads to less efficient plant utilization, and hence lower productivity. Companies cannot easily split large jobs into more efficient smaller job lots because of the difficulty in tracking the more numerous smaller job lots. If a mistake occurs, the typical result is to discard an entire job lot. The larger the job lot size, the greater the potential for substantially more waste.

However, production print shops are moving toward computer-integrated manufacturing (CIM) to provide repeatable, less error prone, end-to end workflows. Automated production print shops will soon use various networking technologies to provide instructions and job parameters to drive equipment and manage resources. These networks will allow enabled devices to be connected together and participate in a CIM workflow. There are a number of legacy devices that currently do not fit this model and would need to either be, replaced with new equipment or retrofitted to provide integrated support.

Also placing computer equipment on a shop floor is problematic as many print shops are unionized. There are different wage scales for each job on the floor and a machine/computer operator would be paid more than just a machine operator. Many machines in a print shop are already computer controlled but it is not the same as a PC interface connected to the machine.

Production print shop floor managers will be faced with new challenges as their environments move towards computer control. Although computers can provide for automation for many production processes human interactions will still be necessary. A print shop manager will need to be equipped with a new set of tools to perform his/her work.

### SUMMARY

There is provided a wireless workflow system for a print shop having multiple printing components comprises a workflow controller and a positioning systems associated with each printing component. A wireless local area network provides communications between the workflow controller and each positioning system, such that each positioning system provides a relative position of the associated printing component to the workflow controller.

A print shop repository includes a database having a record for each printing component. Each record includes at least one field associated with identification information for the printing component and a field for recording the relative position of the printing component. The print shop repository may be disposed in the workflow controller.

The positioning system may be an indoor positioning system or a tablet personal computer. The tablet personal computer includes an operator interface adapted to operate the associated printing component.

The wireless workflow system may further comprise a mobile wireless location aware device in communication with the wireless local area network. The mobile wireless location aware device is adapted for monitoring any printing component having an associated positioning system. The mobile wireless location aware device may include a reading device adapted for reading a job ID associated with a print job.

There is also provided a method of managing a print shop having multiple equipment assets. The method comprises periodically querying the positioning system of each print shop equipment asset over a wireless local area network. Data received from each positioning system in response to the query includes location information and identification information for the associated equipment asset. It is determined whether an inventory database contains a record for the equipment asset associated with the identification information. If the inventory database does not include a record for the equipment asset associated with the identification information, a new record is added and the identification information and location information for the equipment asset is stored in the new record. If the inventory database includes a record for the equipment asset associated with the identification information and the location information received from the positioning system is not identical to location information stored in the record, the location information is updated.

There is further provided a method of managing a print shop having multiple equipment assets. The method comprises maintaining an inventory database of the equipment assets. It is determined what types of print shop components are required to perform a print job. The inventory database is queried to determine what print shop component assets qualify as a required type of component. A print job planner is accessed to determine the availability of the qualifying component assets. Available qualifying component assets are assigned to the print job in the print job planner, which then outputs a job description that is executed in a workflow controller.

### BRIEF DESCRIPTION OF THE DRAWINGS

The present disclosure may be better understood and its numerous objects and advantages will become apparent to those skilled in the art by reference to the accompanying drawings in which:

FIG. 1 is a schematic diagram of a print shop wireless workflow system in accordance with the present disclosure;

FIG. 2 is a flow diagram of a method of maintaining an inventory of print shop equipment assets in accordance with the present disclosure; and

FIG. 3 is a flow diagram of a method of planning a print job in accordance with the present disclosure.

### DETAILED DESCRIPTION

With reference to the drawings wherein like numerals represent like parts throughout the several figures, a print shop wireless workflow system in accordance with the present disclosure is generally designated by the numeral 10.

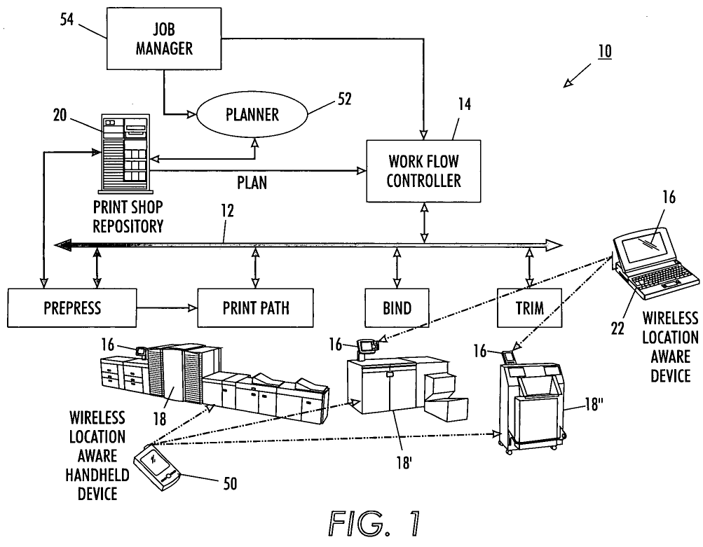

FIG. 1 is a schematic view of a CIM enabled book production system including a print shop wireless workflow system in accordance with the present disclosure. A wireless local area network (WLAN) 12 connects a workflow controller 14 with a positioning system 16 mounted on each component/asset 18, 18′, 18″ of the book production system. It should be appreciated that the positioning system 16 mounted to each component 18, 18′, 18″ may provide the relative position of such component 18, 18′, 18″ to the workflow controller 14 on a continuous, real-time basis, on a periodic basis, or may be manually prompted to transmit the relative position in the event that the location of the component is changed.

A print shop repository 20 includes a database having a record for each book production system asset 18, 18′, 18″. Each asset record includes fields for identification information for the component and a field for recording the WLAN position of the component. The identification information may include the type, model, capabilities/specifications for the component or any other information that may be useful for operating the book production system. The print shop repository 20 may be located in the workflow controller 14 or may be a stand-alone computer unit.

The positioning system 16 may be any wireless location aware device, such as a third-party indoor positioning system or a tablet personal computer (PC) 22 having positioning capability. If a tablet PC 22 is utilized, the PC may determine, via the WLAN 12, the appropriate software to run to provide the equipment operator with the necessary information to setup the machine. If the equipment 18, 18′, 18″ has an interface compatible with those provided by the PC 22 the operator could be provided with an interface to operate the equipment 18, 18′, 18″ directly. For example the Horizon™ BQ-330 perfect binder and the Challenge Titan™ trimmer provide a RS-232 interface to set-up and program the device for operation. It should be appreciated that if a positioning system is utilized as the wireless location aware device, a tablet PC 22 or similar device must also be utilized if an operator interface is desired.

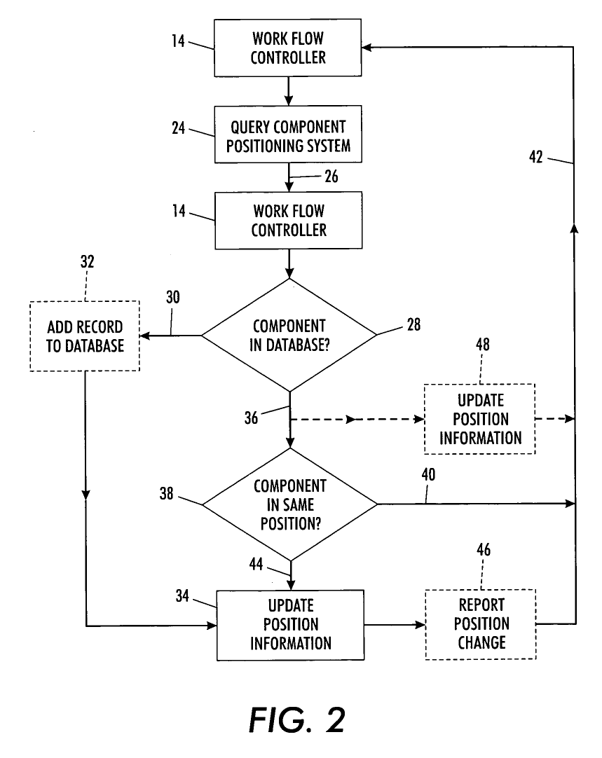

With reference to FIG. 2, in the event that the relative positions of the print shop equipment assets are monitored on a continuous or periodic basis, the workflow controller 14 initiates an enquiry 24 to each printer system component 18, 18′, 18″ connected to the WLAN 12 by a positioning system 16. In response to the enquiry, each such positioning system 16 determines its location and transmits 26 a signal, comprising identification information for the print shop component 18, 18′, 18″ to which it is attached and the location of the component, to the workflow controller 14 over the WLAN 12. For each such signal, the workflow controller queries 28 the print shop asset database to determine whether it contains a record for the component 18, 18′, 18″ associated with the identification information. If the print shop asset database does not 30 include a record for the component, the workflow controller 14 adds 32 a record and stores 34 the identification data for the component 18, 18′, 18″ and the position of the component in the appropriate fields of the record.

If the print shop asset database already includes 36 a record for the component 18, 18′, 18″, the workflow controller 14 may then query 38 such record to determine whether the component location information included in the signal is the same as the location information stored in the record. If the component has not been moved 40, the component location information included in the signal will be the same as the location information stored in the record and the workflow controller will loop back 42 to initiate another position enquiry 24 to the print shop components 18, 18′, 18″. If the component has been moved 44, the component location information included in the signal will not be the same as the location information stored in the record and the workflow controller will update 34 the position information, storing the new component information in the appropriate field of the record, and then loop back 42 to initiate another position enquiry 24 to the print shop components. The workflow controller 14 may also report 46 that the print shop component has been moved from its previous location. Alternatively, the workflow controller 14 may simply update 48 the position information, storing the new component information in the appropriate field of the record, and then loop back 42 to initiate another position enquiry 24 to the print shop components.

A mobile wireless location aware device 50, such as a pocket PC, carried by a print shop manager could operate in a mode that allows the manager to monitor work on the shop floor as he/she moves through the shop. For example, via the WLAN 12, the manager could stop near a wireless workflow enabled binding station 18′ and view the current role of the device without disturbing the operator. The manager could then access the planner 52 to determine which trimmer apparatus 18″ was scheduled to be used for the print job currently in the binding station 18′, and then access such trimmer apparatus 18″ to view its status.

Many pocket and tablet PCs 50, 22 have multimedia capabilities and these features may be used to enable a new set of communication and management tools for the print shop. For example an equipment operator could access an application to page the shop floor manager. An application running on the manager's handheld device 50 would monitor and answer the page. By using speakers and microphones in the wireless devices a direct line of audio communication could be established between the two parties allowing them to communicate. Also the user interfaces on each device could be used to share and collaborate other types of information.

The pocket or tablet PC 50, 22 may include apparatus for reading the job ID (barcode, rfid) and then use the ID to access job parameters on the wireless network. Using these parameters the PC 50, 22 can then direct the set-up and programming of the device. The PC 50, 22 may provide a direct connection to the machine if such an interface is supported. If the device has no support for this type of connection the multi-media capabilities of the PC 50, 22 could be used to provide the machine operator with the necessary information to set-up the device.

In addition to the print shop asset database, the repository 20 also includes a database for storing information related to the job requests submitted to the print shop. The workflow controller stores persistent job status information in a manner that allows access to such information as the print job is processed. One method of storing such data is with a print job database of the type described in U.S. Pat. No. 5,436,730 to Hube, issued Jul. 25, 1995 (hereby incorporated by reference).

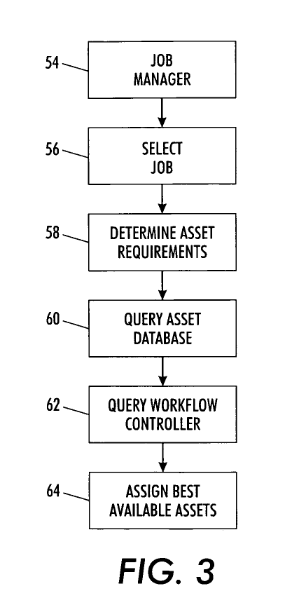

With reference to FIG. 3, the shop floor manage 54 can select 56 a job and plan it against currently available shop resources. The job planner first determines 58 what type of print shop components are required to perform the selected print job. The planner then queries 60 the print shop asset database to determine what print shop components 18, 18′, 18″ meet the requirements for the selected print job and then queries 62 the workflow controller 14 to determine the availability of the print shop components 18, 18′, 18″ that qualify for the selected print job. Finally, the planner assigns 64 the best available, qualified print shop components 18, 18′, 18″ to the print job. The planner produces as output a job description that can be executed by a workflow controller 14. Execution of the job results in a computer controlled orchestration of specific processes (prepress, print, bind, trim) to produce a perfect bound book. By adding a wireless interface to the binding and trimming equipment the services provided by these machines can now be fully coordinated in a CIM workflow.

One of the benefits associated with this technique is that the job many be rerouted to another device with out the need for regenerating job programming sheets. Also changes in up stream process may effect the set-up and programming of a down stream step in the workflow (e.g. selection of and alternate print stock).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A wireless workflow system for a print shop including a plurality of printing components comprises:
a workflow controller;
a plurality of positioning systems, a one of the positioning systems being associated with each printing component; and
a wireless local area network providing communications between the workflow controller and each positioning system, whereby each positioning system provides a relative position of the associated printing component to the workflow controller.

2. The wireless workflow system of claim 1 further comprising a print shop repository including a database having a record for each printing component, each record including at least one field associated with identification information for the printing component and a field for recording the relative position of the printing component.

3. The wireless workflow system of claim 2 wherein the print shop repository is disposed in the workflow controller.

4. The wireless workflow system of claim 1 wherein the positioning system is an indoor positioning system.

5. The wireless workflow system of claim 1 wherein the positioning system is a tablet personal computer.

6. The wireless workflow system of claim 5 wherein the tablet personal computer includes an operator interface adapted to operate the associated printing component.

7. The wireless workflow system of claim 1 further comprising a mobile wireless location aware device in communication with the wireless local area network.

8. The wireless workflow system of claim 7 wherein the mobile wireless location aware device is adapted for monitoring any printing component having an associated positioning system.

9. The wireless workflow system of claim 7 wherein the mobile wireless location aware device includes a reading device adapted for reading a job ID associated with a print job.

10. A method of managing a print shop having a plurality of equipment assets, the method comprising:
maintaining an inventory database of the equipment assets by
determining a position of each equipment asset with a positioning system associated with the equipment asset, and
storing position information for each equipment asset in the inventory database; and
planning a print job utilizing the inventory database.

11. The method of claim 10 wherein determining the position of each equipment asset includes:
querying the positioning system of each print shop equipment asset over a wireless local area network; and
receiving data from each positioning system over the wireless local area network in response to the query.

12. The method of claim 11 wherein the data received from each positioning system includes location information and identification information for the associated equipment asset, and the method also comprises:
determining whether the inventory database contains a record for the equipment asset associated with the identification information;
adding a new record if the inventory database does not include a record for the equipment asset associated with the identification information; and
storing the identification information and location information for the equipment asset in the new record.

13. The method of claim 12 wherein if the inventory database includes a record for the equipment asset associated with the identification information, the method further comprises:
querying the record for the equipment asset associated with the identification information to determine whether the location information received from the positioning system is identical to location information stored in the record; and
storing the location information received from the positioning system in the record for the equipment asset associated with the identification information if the location information received from the positioning system is not identical to location information stored in the record, and
querying the positioning system of the print shop equipment asset over the wireless local area network, or
querying the positioning system of the print shop equipment asset over the wireless local area network if the location information received from the positioning system is identical to location information stored in the record.

14. The method of claim 12 wherein if the inventory database includes a record for the equipment asset associated with the identification information, the method further comprises:
storing the location information received from the positioning system in the record for the equipment asset associated with the identification information; and
querying the positioning system of the print shop equipment asset over the wireless local area network.

15. The method of claim 10 further comprising monitoring operation of a one of the equipment assets with a mobile location aware device over a wireless local area network.

16. The method of claim 10 further comprising:
accessing a print job planner with a mobile location aware device over a wireless local area network;
identifying which equipment asset is scheduled to be used next for a print job; and
accessing the identified equipment asset to determine the status of the identified equipment asset.

17. The method of claim 10 wherein planning the print job comprises:
determining what types of print shop components are required to perform the print job;
querying the inventory database to determine what print shop component assets qualify as a required type of component;
accessing a print job planner to determine the availability of the qualifying component assets; and
assigning available qualifying component assets to the print job in the print job planner.

18. The method of claim 17 wherein planning the print job also comprises:
outputting a job description from the print job planner; and
executing the job description in a workflow controller.

19. A method of managing a print shop having a plurality of equipment assets, the method comprising:
periodically querying the positioning system of each print shop equipment asset over a wireless local area network;
receiving data from each positioning system over the wireless local area network in response to the query, the data including location information and identification information for the associated equipment asset; and
determining whether an inventory database contains a record for the equipment asset associated with the identification information and
adding a new record and storing the identification information and location information for the equipment asset in the new record, if the inventory database does not include a record for the equipment asset associated with the identification information, or
updating the location information if the inventory database includes a record for the equipment asset associated with the identification information, and the location information received from the positioning system is not identical to location information stored in the record.

20. A method of managing a print shop having a plurality of equipment assets, the method comprising:
maintaining an inventory database of the equipment assets;
determining what types of print shop components are required to perform the print job;
querying the inventory database to determine what print shop component assets qualify as a required type of component;
accessing a print job planner to determine the availability of the qualifying component assets;
assigning available qualifying component assets to the print job in the print job planner;
outputting a job description from the print job planner; and
executing the job description in a workflow controller.
